(19) United States
(12) Patent Application Publication
(10) Pub. No.: US 2020/0124789 A1
(43) Pub. Date: Apr. 23, 2020

(54) BACKLIGHT MODULE

(71) Applicant: Coretronic Corporation, Hsin-Chu (TW)

(72) Inventors: Pei-Ting Huang, Hsin-Chu (TW); Yao-Cheng Lu, Hsin-Chu (TW); Xin-Xian Li, Hsin-Chu (TW)

(73) Assignee: Coretronic Corporation, Hsin-Chu (TW)

(21) Appl. No.: 16/656,550

(22) Filed: Oct. 17, 2019

(30) Foreign Application Priority Data
Oct. 22, 2018 (CN) 201821706534.6

(51) Int. Cl. F21V 8/00

(52) U.S. Cl. CPC G02B 6/0088; G02B 6/005; G02B 6/0055; G02B 6/0091

(57) ABSTRACT

A backlight module includes a back cover, a light source, a light guide plate and a first adhesive. The light source includes a substrate and at least one light emitting device. The substrate is disposed on the back cover. The light emitting device is disposed on the substrate. The light guide plate is disposed on the back cover and has a light incidence surface, a light emitting surface and a back surface. The back surface is opposite to the light emitting surface. The light incidence surface is connected between the back surface and the light emitting surface and faces the light emitting device. The first adhesive is adhered between the light guide plate and the substrate. The backlight module of the present invention can prevent an unexpected gap from appearing between the light emitting surface of the light guide plate and the light emitting device.

### CROSS-REFERENCE TO RELATED APPLICATION

This application claims the priority benefit of China application serial no. 201821706534.6, filed on Oct. 22, 2018. The entirety of the above-mentioned patent application is hereby incorporated by reference herein and made a part of this specification.

### BACKGROUND

### Field of the Invention

The invention relates to a backlight module and more particularly, to a backlight module having a light guide plate.

### Description of Related Art

Regarding a conventional backlight module, it generally includes a back cover, a light guide plate, a reflector and a light source. Light generated by the light source which enters the light guide plate from a light incidence surface at a side edge of the light guide plate is output from a light emitting surface of the light guide plate with the aid of the reflector and is adjusted by an optical film to provide a uniform surface light source. Because the light guide plate is expanded and contracted according to ambient temperature and humidity changes, the size change would lead to a change in a light emitting efficiency of the backlight module. Thus, in configuration, a space for the size change of the light guide plate being expanded and contracted due to the affection from the environment has to be retained.

A currently common method for the light guide plate is to adhere an end of the light guide plate which is far away from the light incidence surface to the back cover by using a tape, without fixing an end of the light guide plate where the light incidence surface is located through adhesion. In this disposition, when the light guide plate is contracted with a temperature change, displacement occurs to the end of the light guide plate where the light incidence surface is located due to not being fixed through adhesion. As a result, an unexpected gap appears between the light incidence surface of the light guide plate and the light emitting device, which influences a light emitting efficiency of the backlight module.

The information disclosed in this Background section is only for enhancement of understanding of the background of the described technology and therefore, it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention provides a backlight module capable of preventing any unexpected gap from appearing between a light emitting surface of a light guide plate and a light emitting device.

A backlight module of the invention includes a back cover, a light source, a light guide plate and a first adhesive. The light source includes a substrate and at least one light emitting device, wherein the substrate is disposed on the back cover, and the light emitting device is disposed on the substrate. The light guide plate is disposed on the back cover and has a light incidence surface, a light emitting surface and a back surface, wherein the back surface is opposite to the light emitting surface, and the light incidence surface is connected between the back surface and the light emitting surface and faces the light emitting device.

To sum up, in the invention, an end of the light guide plate where the light incidence surface is located is fixed to the substrate of the light source with the first adhesive, such that an end of the light guide plate which is opposite to the light incidence surface does not have to be fixed through adhesion. In this way, when the light guide plate is contracted with a temperature change, the displacement occurs to the end of the light guide plate which is opposite to the light incidence surface, instead of the end of the light guide plate where the light incidence surface is located, and thus, the unexpected gap can be prevented from appearing between the light incidence surface of the light guide plate and the light emitting device, which can facilitate the backlight module to maintain preferable light emitting efficiency.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a backlight module according to an embodiment of the invention.

FIG. 2 is a schematic cross-sectional view of a backlight module according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

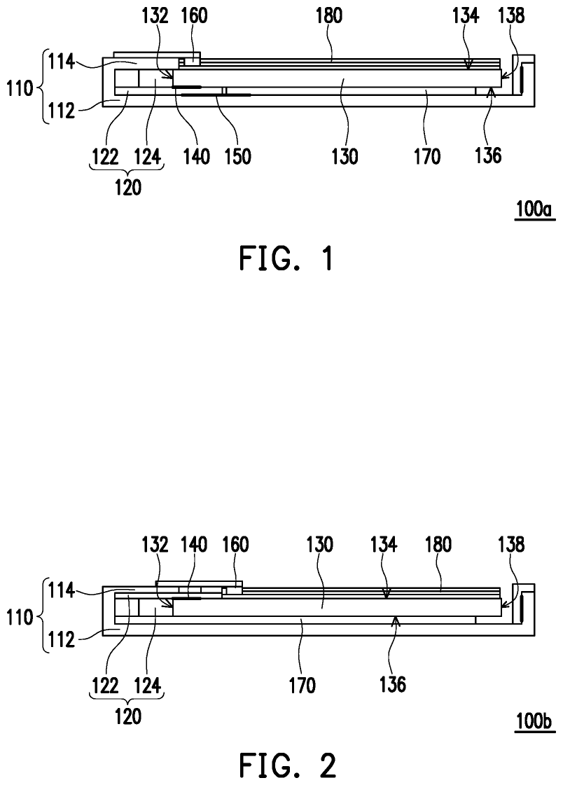

FIG. 1 is a schematic cross-sectional view of a backlight module according to an embodiment of the invention. Referring to FIG. 1, a backlight module 100a of the present embodiment includes a back cover 110, a light source 120, a light guide plate 130 and a first adhesive 140. The light source 120 includes a substrate 122 and at least one light emitting device 124. The substrate 122 is, for example, a flexible circuit board and disposed on the back cover 110. The light emitting device 124 is disposed on a top surface of the substrate 122 and used to generate light. In the present embodiment, the light emitting device 124 is, for example, a light emitting diode (LED) or other adaptive light emitting devices. The number of the at least one light emitting device 124 may be adjusted based on a requirement, which is not particularly limited in the invention.

In the present embodiment, the light guide plate 130 is an optical element used to convert the light generated by the light emitting device 124 into a surface light source in the backlight module 100a. The light guide plate 130 has a light incidence surface 132, a light emitting surface 134 and a back surface 136. The back surface 136 is opposite to the light emitting surface 134. The light incidence surface 132 is close to the light emitting device 124, is connected between the back surface 136 and the light emitting surface 134 and faces the light emitting device 124. The light guide plate 130 is disposed on the back cover 110 with the back surface 136 facing the back cover 110.

As illustrated in FIG. 1, the first adhesive 140 is adhered between the back surface 136 of the light guide plate 130 and the top surface of the substrate 122 of the light source 120, such that the light guide plate 130 may be stably fixed to the substrate 122. Therefore, the light guide plate 130 does not have to be fixed to the back cover 110 through adhesion at the position of the side surface 138 which is opposite to the light incidence surface 132. Thereby, when the light guide plate 130 is contracted with a temperature change, displacement occurs to an end of the light guide plate 130 which is opposite to the light incidence surface 132 (i.e., the side surface 138 of the light guide plate 130), instead of an end of the light guide plate 130 where the light incidence surface 132 is located, and thus, an unexpected gap may prevented from appearing between the light incidence surface 132 of the light guide plate 130 and the light emitting device 124, which facilitates the backlight module 100a to maintain preferable light emitting efficiency.

In the present embodiment, the backlight module 100a further includes a second adhesive 150 and a reflector 170. The reflector 170 is disposed between the back surface 136 of the light guide plate 130 and the back cover 110. The second adhesive 150 is adhered between a bottom surface of the substrate 122 of the light source 120 and the back cover 110 and adhered between the reflector 170 and the back cover 136, thereby stably fixing the substrate 122 of the light source 120 and the reflector 170 to the back cover 136.

Referring to FIG. 1, in the present embodiment, the back cover 110 includes a back cover body 112 and an extending portion 114. The substrate 122 of the light source 120 is disposed on the back cover body 112, the back surface 136 of the light guide plate 130 faces the back cover body 112, and the light incidence surface 132 of the light guide plate 130 faces the extending portion 114. The extending portion 114 extends from an edge of the back cover body 112 toward the light emitting surface 134 of the light guide plate 130 and covers the light source 120.

Accordingly, the backlight module 100a of the present embodiment further includes an optical film set 180 and a third adhesive 160. The optical film set 180 is disposed on the light emitting surface 134 of the light guide plate 130. The third adhesive 160 is adhered to the extending portion 114 of the back cover 110 and extends to the optical film set 180 to be adhered to optical film set 180, so as to fix the optical film set 180. The optical film set 180 is adapted to adaptively scatter light beams from the light guide plate 130, thereby enhancing uniformity of the light beams from the light guide plate 130. In other embodiments, the optical film set 180 may also be optical films with other functions, and the invention is not limited thereto.

In the present embodiment, the first adhesive 140 is adjacent to the light incidence surface 132 of the light guide plate 130. Accordingly, the first adhesive 140 is located at an edge of the light emitting surface 134 of the light guide plate 130 and is far away from a central region (corresponding to a visible region of a display apparatus) of the light guide plate 130, and thus, an phenomenon of poor light emitting effect or the presence of a dark region due to uneven adhesion of the adhesives may be prevented.

FIG. 2 is a schematic cross-sectional view of a backlight module according to another embodiment of the invention. Referring to FIG. 2, a backlight module 100b of the present embodiment is substantially similar to the backlight module 100a illustrated in FIG. 1 and is different therefrom mainly in that a substrate 122 of the present embodiment is disposed under the extending portion 114 of the back cover 110, the light emitting device 124 is disposed under the substrate 122, the first adhesive 140 is adhered between the light emitting surface 134 of the light guide plate 130 and the substrate 122 of the light source 120, such that the effect of fixing the light guide plate 130 may be achieved in the same way.

Based on the above, in the invention, the end of the light guide plate where the light incidence surface is located is fixed to the substrate of the light source with the first adhesive, such that the end of the light guide plate which is opposite to the light incidence surface does not have to be fixed through adhesion. In this way, when the light guide plate is contracted with the temperature change, the displacement occurs to the end of the light guide plate which is opposite to the light incidence surface, instead of the end of the light guide plate where the light incidence surface is located, and thus, the unexpected gap can be prevented from appearing between the light incidence surface of the light guide plate and the light emitting device, which can facilitate the backlight module to maintain preferable light emitting efficiency.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a back cover;
a light source, comprising a substrate and at least one light emitting device, wherein the substrate is disposed on the back cover, and the light emitting device is disposed on the substrate;
a light guide plate, disposed on the back cover and having a light incidence surface, a light emitting surface and a back surface, wherein the back surface is opposite to the light emitting surface, and the light incidence surface is connected between the back surface and the light emitting surface and faces the light emitting device; and
a first adhesive, adhered between the light guide plate and the substrate.

2. The backlight module according to claim 1, wherein the first adhesive is adhered between the back surface of the light guide plate and the substrate.

3. The backlight module according to claim 1, further comprising a second adhesive, wherein the second adhesive is adhered between the substrate and the back cover.

4. The backlight module according to claim 3, further comprising a reflector, wherein the reflector is disposed between the back surface of the light guide plate and the back cover, and the second adhesive is further adhered between the reflector and the back cover.

5. The backlight module according to claim 1, wherein the first adhesive is adhered between the light emitting surface of the light guide plate and the substrate.

6. The backlight module according to claim 1, wherein the back cover comprises a back cover body and an extending portion, the back surface of the light guide plate faces the back cover body, and the extending portion extends from an edge of the back cover body toward the light emitting surface of the light guide plate and covers the light source.

7. The backlight module according to claim 6, wherein the substrate of the light source is disposed on the back cover body.

8. The backlight module according to claim 6, wherein the substrate of the light source is disposed on the extending portion.

9. The backlight module according to claim 6, further comprising an optical film set and a third adhesive, wherein the optical film set is disposed on the light emitting surface of the light guide plate, and the third adhesive is adhered to the extending portion and extends to the optical film set to be adhered to the optical film set.

10. The backlight module according to claim 1, wherein the first adhesive is adjacent to the light incidence surface of the light guide plate.

11. The backlight module according to claim 1, wherein the light guide plate has a side surface which is opposite to the light incidence surface, and the light guide plate is not adhered to the back cover at a position of the side surface.
